(19) United States
(12) Patent Application Publication
(10) Pub. No.: US 2024/0102398 A1
(43) Pub. Date: Mar. 28, 2024

(54) MODULE FOR A TURBOMACHINE

(71) Applicant: MTU Aero Engines AG, Muenchen (DE)

(72) Inventors: Manfred FELDMANN, Eichenau (DE); Bernd KISLINGER, Reisgang (DE); Christoph NITSCH, Munich (DE); Markus SCHLEMMER, Mainburg / Sandelzhausen (DE); Rudolf STANKA, Rattenkirchen (DE)

(21) Appl. No.: 18/370,528

(22) Filed: Sep. 20, 2023

(30) Foreign Application Priority Data
Sep. 22, 2022 (DE) 102022124401.6

(51) Int. Cl. F01D 11/00; F01D 9/02

(52) U.S. Cl. CPC F01D 11/001; F01D 9/02; F05D 2220/323; F05D 2240/12; F05D 2240/55

(57) ABSTRACT

A module for a turbomachine, including a guide blade arrangement, a seal carrier that is situated radially within an inner platform of the guide blade arrangement, seal carrier walls, namely, a first seal carrier wall and a second seal carrier wall, and a sliding body as well as a connecting element. The seal carrier walls have a multipart design with respect to one another, and the second seal carrier wall is fastened to the first seal carrier wall and to the seal carrier via the connecting element. The sliding body holds the seal carrier walls at a distance from one another in such a way that they mutually axially delimit a clearance in which the guide blade arrangement engages via a radially inwardly extending guide pin. A radially inner section of the second seal carrier wall has frictional contact relative to the seal carrier.

This claims the benefit of German Patent Application 102022124401.6, filed on Sep. 22, 2022 which is hereby incorporated by reference herein.

The present invention relates to a module for a turbomachine.

### BACKGROUND INFORMATION

The turbomachine may be a jet engine, for example, such as a turbofan engine. The turbomachine is functionally divided into a compressor, a combustion chamber, and a turbine. In the case of the jet engine, for example, aspirated air is compressed by the compressor and combusted with admixed jet fuel in the downstream combustion chamber. The resulting hot gas, a mixture of combustion gas and air, flows through the downstream turbine and is thereby expanded. In the process, the turbine also proportionally withdraws energy from the hot gas in order to drive the compressor. The turbine and the compressor generally each have a multistage design, a stage in each case including a guide blade ring and a rotor blade ring.

The subject matter of the present invention relates to a guide blade arrangement and a seal carrier. The guide blades of the guide blade arrangement extend radially between a radially outer, outer platform and a radially inner, inner platform. The seal carrier is situated radially within this inner platform, and forms a portion of the so-called inner air seal (IAS). The seal carrier assists with reducing or avoiding gas losses, which is advantageous with regard to the efficiency of the turbomachine. The intent is for the greatest possible portion, or if possible, the entire fluid or gas, to flow through the gas duct of the turbomachine.

### SUMMARY OF THE INVENTION

A technical object underlying the present invention is to provide a particularly advantageous module for a turbomachine.

The present invention provides a module. In this module, the seal carrier and the guide blade arrangement are mounted relative to one another with the aid of a first and a second seal carrier wall, for which purpose the seal carrier walls mutually axially delimit a clearance in which the guide blade arrangement engages from radially outside with one or two guide pins. The second seal carrier wall is provided in multiple parts with respect to the first seal carrier wall; i.e., as a part that was previously separate, is combined with the first seal carrier wall and fastened thereto. This fastening is achieved using a connecting element, a sliding body, situated in the clearance, holding seal carrier walls at the defined distance so that they delimit the clearance. Although the second seal carrier wall is fastened to the first seal carrier wall, and thus also to the seal carrier, via the sliding body and the connecting element, a radially inner section of the second seal carrier wall still has axial or radial contact relative to the seal carrier.

The radially inner section is intended to abut the seal carrier via frictional engagement (see a more detailed description below), but is not, for example, integrally joined thereto. In particular, the radially inner section may abut solely via frictional engagement and not be directly connected to the seal carrier, for example integrally joined and/or connected in a form-fit manner. The radially inner section may be free and/or unconnected. The radially inner section may abut via frictional engagement, in particular axially and/or radially, and/or may otherwise extend freely. For example, stresses in the components, in particular in the seal carrier, may thus be reduced, and, for example, an assembly clearance due to deformations does not have to be closed. The multipart design of the seal carrier walls may be advantageous with regard to manufacture, for example, since in comparison, for example for two seal carrier walls formed monolithically with the seal carrier and a material-removing manufacture, the clearance would have to be exposed via a comparatively deep recess. Regardless, the multipart design may also provide options for material selection or material thickness; namely, the second seal carrier wall may, for example, be provided in a thinner design and in particular in the form of a metal sheet, thus providing leeway for weight optimization.

Preferred specific embodiments are provided in the dependent claims and the overall disclosure, in the description of the features, a distinction not always being made in particular between the module and the turbomachine, or corresponding methods or uses. The disclosure is to be construed with regard to all claim categories.

In general, within the scope of the present disclosure, “axial” or “axial direction” refers to the longitudinal axis of the module, i.e., the longitudinal axis of the turbomachine. This longitudinal axis may, for example, coincide with a rotational axis about which the rotor blades associated with the guide blade arrangement rotate during operation. “Radial” refers to the radial directions perpendicular thereto, pointing away from the longitudinal axis, and the “circumference” or the “circumferential direction” refers to a rotation about the longitudinal axis. Unless expressly stated otherwise, “inner” and “outer” refer to the radial direction; thus, “inner” is closer to the longitudinal axis than “outer.” If reference is made to an axial section, this refers to a section plane that contains the longitudinal axis.

Relative to a flow of the working gas through the gas duct of the module, which, for example, flows around the rotor blade airfoils of the rotor blade arrangement, “in front of” means upstream and “to the rear of” means downstream. In one preferred embodiment, the first seal carrier wall is situated in front and the second seal carrier wall is situated to the rear; thus, the first seal carrier wall is upstream and the second seal carrier wall is downstream. However, at the same time, when further reference is made to the first and second seal carrier walls in the following discussion, “first” is always to be understood as “front,” and “second,” as “rear.”

The seal carrier may bear a sealing element radially on the inside, for example, which may seal inwardly toward a sealing structure, such as a sealing tip or sealing fin, and which rotates together with the shaft or the rotor blades during operation. For example, a brush seal or a so-called honeycomb seal, or in general terms an inlet coating, may be provided as a sealing element. As explained in greater detail below, the first seal carrier wall may preferably be formed monolithically with the seal carrier, and the two elements, observed in an axial section, then being able to form in particular a T shape (the first seal carrier wall thus being spaced apart from the axial ends of the seal carrier).

The connecting element may generally also be a screw or a stud bolt, for example, but is preferably implemented in the form of a rivet. Regardless, the seal carrier walls may be distributed over the circumference and fastened to one another via multiple connecting elements (and sliding bodies), and these sliding bodies may in particular form a so-called spoke centering, as explained in greater detail below. In general, within the scope of the present disclosure, unless expressly stated otherwise, “a” and “an” are to be understood as the indefinite article, and thus also as “at least one.”

The “radially inner section” of the second seal carrier wall may in particular be situated radially within the connecting element or formed at the radially inner end of the second seal carrier wall. A frictionally engaged abutment thus exists; i.e., although the second seal carrier wall is held in abutment with the seal carrier via a contact force, the second seal carrier wall is not fixed in this abutment in a form-fit and/or integrally joined manner. The frictionally engaged abutment, which is achieved with a certain pretensioning, may be advantageous, for example, with regard to a damping, for example to reduce vibrations of the seal carrier.

According to one preferred specific embodiment, the frictionally engaged abutment is designed as a radial abutment between a lateral surface of the second seal carrier wall facing the first seal carrier wall, and an abutment surface of the seal carrier. This abutment surface is preferably formed at a step in an outwardly facing top-side surface of the seal carrier, the radially inner end of the second seal carrier wall not resting thereon. Instead, between the top-side surface and this end, a gap is formed which allows the radial play. The second seal carrier wall and the seal carrier then preferably abut one another solely in the abutment surface at the stage, and therefore there is/are no further abutment surface(s).

In one alternatively preferred specific embodiment. the radially inner section of the second seal carrier wall, viewed in an axial section, extends radially inwardly at an angle, i.e., partly axially and partly radially. An angled extension toward the inside, and at the same time, away from the first seal carrier wall, is preferred. The angled inner section may act as a spring element, i.e., may ensure a certain contact force.

In one preferred embodiment, the second seal carrier wall with its radially inner end abuts solely the seal carrier, and apart from that, the angled radially inner section extends freely, i.e., spaced apart from the top-side surface of the seal carrier.

According to one preferred specific embodiment, a sealing web which, viewed in an axial section, extends away from the at least one seal carrier wall and the clearance is situated at at least one of the seal carrier walls. In the case of the first/front seal carrier wall, the sealing web thus extends axially to the front, whereas in the case of the second/rear seal carrier wall, the sealing web extends away therefrom, axially to the rear. The sealing web together with the inner platform of the guide blade arrangement forms a so-called labyrinth seal or fishmouth seal. This seal may also be formed in part, together with the inner platform of a rotor blade arrangement situated directly upstream in the case of the front sealing web, or situated directly downstream in the case of the rear sealing web. The inner platform of the rotor blade arrangement may then be situated on a radial position between the inner platform and the sealing web.

In summary, it is preferred that a front sealing web is situated at the front seal carrier wall, and/or a rear sealing web is situated at the rear seal carrier wall, particularly preferably both.

According to one preferred specific embodiment, the sealing web is provided in a multipart design with respect to the seal carrier wall, and is fastened to the seal carrier wall via the connecting element. In one alternatively preferred specific embodiment, which may relate in particular to the rear seal carrier wall, the sealing web is formed monolithically with the seal carrier wall, i.e., integrally formed from the same continuous material. If the second seal carrier wall is provided as a metal sheet (see a more detailed description below), for example a radially outer section thereof may be appropriately bent (and viewed in an axial section, may extend axially, at least in part). Combinations are also possible; for example, the front sealing web may be provided in a multipart design and be fastened to the front seal carrier wall via the connecting element, the rear sealing web either likewise having a multipart design with respect to the rear seal carrier wall, or being monolithically formed with same in the manner described above.

In general, the sliding body may, for example, also be provided monolithically with one of the seal carrier walls, i.e., the first or in particular the second seal carrier wall. However, in one preferred embodiment, the sliding body has a multipart design with respect to the seal carrier walls, and the connecting element passes through the sliding body axially. The latter is also preferred in the case of a monolithic design, but is not mandatory. The connecting element, which passes through the multipart sliding body, holds the sliding body radially in a form-fit manner between the seal carrier walls, and the sliding body is then even further axially clamped, for example.

In one preferred embodiment, the second seal carrier wall has a smaller thickness than the first seal carrier wall; i.e., the multipart design is utilized for weight optimization. The thicknesses are viewed in each case in an axial section, in the case of a thickness that varies over the extension of the particular seal carrier wall, the thickness being based on an average value.

According to one preferred specific embodiment, the second seal carrier wall is formed from a metal sheet, which may allow a particularly thin design and/or simple manufacture. The metal sheet may generally be segmented in the circumferential direction, i.e., provided in a multipart design. However, a design that is continuous, i.e., not divided/segmented in the circumferential direction, is preferred.

As already mentioned at the outset, in one preferred embodiment the first seal carrier wall is formed monolithically with the seal carrier, i.e., made of the same interruption-free, continuous material. Since the second seal carrier wall is attached separately, and therefore the clearance does not have to be taken into account during manufacture of the seal carrier, the monolithic manufacture of the seal carrier and the first seal carrier wall may be simplified, for example may take place by casting.

The guide pin via which the guide blade arrangement engages with the clearance extends radially inwardly from the inner platform of the guide blade arrangement. Relative to the circumferential direction, the guide pin preferably abuts the sliding body, i.e., on the circumferential side. In one preferred embodiment, the guide pin encloses the sliding body together with a further guide pin that abuts the side of the sliding body on the opposite side in the circumferential direction. The sliding body is thus held between the guide pins, also referred to as “tang.” The guide pins and the sliding body may still slide radially against one another, there being multiple sliding bodies, circumferentially distributed, that are similarly held, so that the arrangement represents a spoke centering.

Moreover, the present invention relates to a turbine for a turbomachine, in particular for an aircraft engine, that includes a module described here.

### BRIEF DESCRIPTION OF THE DRAWINGS

The present invention is explained in greater detail below with reference to one exemplary embodiment, it being possible for the individual features, within the scope of the other independent claims [besides the main claim], to also be in some other combination that is essential to the present invention, in particular a distinction also not being made between the different claim categories.

In the figures:

FIG. 1 shows a jet engine in an axial section;

FIG. 2 shows a first module according to the present invention, with a guide blade arrangement and a seal carrier in an axial section;

FIG. 3 shows a second module according to the present invention, with a guide blade arrangement and a seal carrier;

FIG. 4 shows a third module according to the present invention, with guide blade arrangements and a seal carrier;

FIG. 5 shows a fourth module according to the present invention, with a guide blade arrangement and a seal carrier; and

FIG. 6 shows a fifth module according to the present invention, with a guide blade arrangement and a seal carrier.

### DETAILED DESCRIPTION OF THE INVENTION

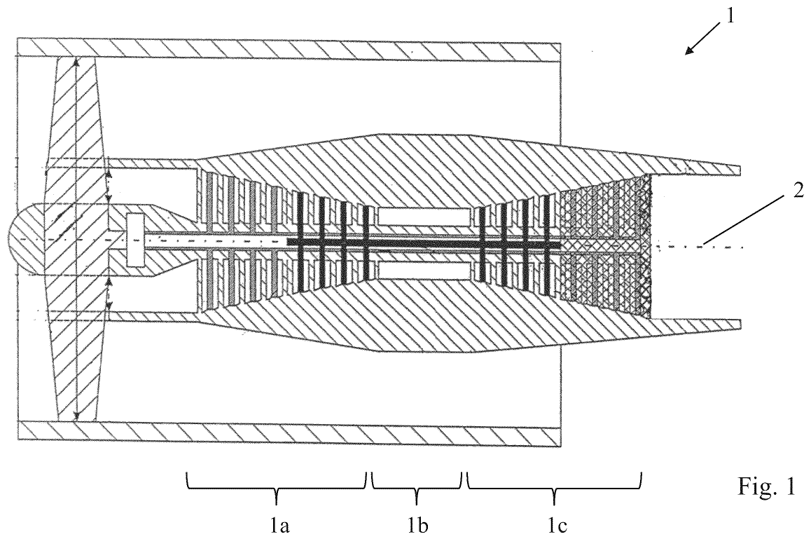

FIG. 1 shows a turbomachine 1, specifically, a jet engine, in a schematic view. Turbomachine 1 is functionally divided into compressor 1a, combustion chamber 1b, and turbine 1c. Compressor 1a and turbine 1c are each built from multiple stages, and each stage is made up of a guide blade ring and a rotor blade ring. In the case of turbine 1c, the rotor blade ring in each case is situated downstream from the associated guide blade ring. During operation, the rotor blades rotate about longitudinal axis 2.

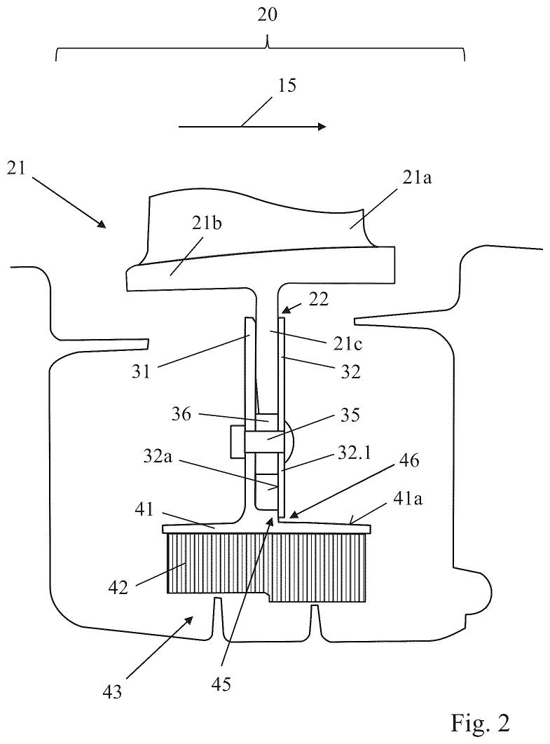

FIG. 2 shows a detail of turbine 1c, once again in an axial section, as module 20. Apparent in particular are a guide blade arrangement 21 including a guide blade airfoil 21a and an inner platform 21b, as well as a guide pin 21c. Guide blade airfoil 21a is situated radially on the outside at inner platform 21b, and guide pin 21c extends radially within the guide blade airfoil into a clearance 22. This clearance 22 is axially delimited between a first, front seal carrier wall 31 and a second, rear seal carrier wall 32. First seal carrier wall 31 is situated upstream from module 20, and second seal carrier wall 32 is situated downstream from module 20, relative to a through flow 15.

First seal carrier wall 31 is formed monolithically with a seal carrier 41; both may be manufactured as a cast part, for example. Provided radially on the inside at seal carrier 41 is a sealing element 42, for example a honeycomb seal and/or an inlet coating, in particular for an inlet structure such as a sealing fin. Sealing element 42 seals against a sealing structure 43, illustrated only schematically in the present case as a contour, and rotates together with the shaft during operation. Sealing structure 43 may include an inlet structure, which in turn may include sealing fins.

In the illustrated examples in FIGS. 2 through 6, sealing structure 43 includes two sealing fins in each case.

Second seal carrier wall 32 is provided with a multipart design with respect to first seal carrier wall 31, and is fastened thereto via connecting element 35, a rivet in the present case. Connecting element 35 passes through a sliding body 36 which holds seal carrier walls 31, 32 at the defined distance from one another. Although second seal carrier wall 32, in particular a radially inner section 32.1 thereof, abuts seal carrier 41 with a lateral surface 32a that faces first seal carrier wall 31, the second seal carrier wall has radial play. This is achieved by a frictionally engaged axial abutment at a step 45 that is formed in top-side surface 41a of seal carrier 41, despite this abutment gap 46 still remaining between second seal carrier wall 32 and top-side surface 41a.

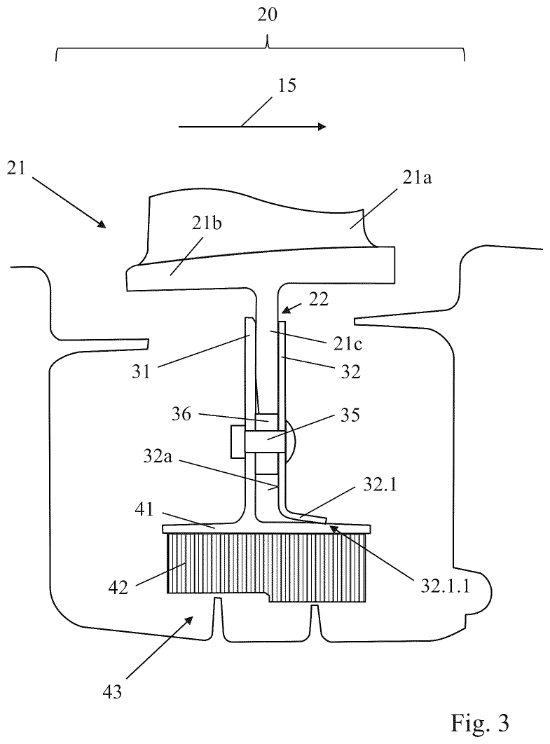

FIG. 3 shows an alternative design to FIG. 2, in the following illustration primarily the differences being emphasized, and in other respects reference being made to the above description. In general, within the scope of the present disclosure, identical parts or parts having the same function are denoted by the same reference numerals, and in this regard reference is always made to the description for the respective other figures. Also in the variant according to FIG. 3, second seal carrier wall 32 abuts seal carrier 41 via frictional engagement, but in contrast to FIG. 2 abuts radially, not axially. Inner section 32.1 extends inwardly at an angle with respect to the longitudinal axis, not illustrated here, and abuts only with its radially inner end 32.1.1 against top-side surface 41a (denoted by a reference numeral only in FIG. 2, but not in FIG. 3) of seal carrier 41.

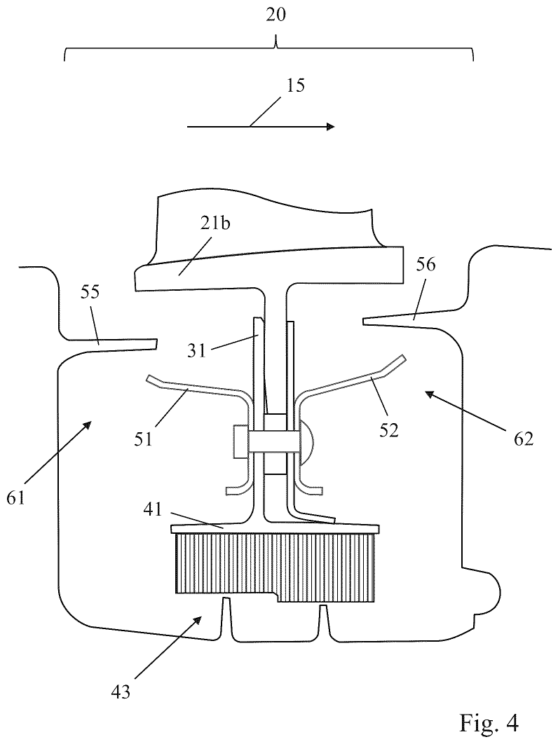

Designs that are modified from the variant according to FIG. 3 are described below, it being likewise possible for these modifications to be achieved based on the variant according to FIG. 2 (which, however, is not described in detail). For the sake of clarity, fewer reference numerals are illustrated in FIG. 4 than in FIG. 3; however, in this regard module 20 has an analogous design. In addition, in FIG. 4 a front sealing web 51 is fastened to first seal carrier wall 31, and a rear sealing web 52 is fastened to second seal carrier wall 32.

Sealing webs 51, 52 are attached as multi-piece parts with respect to seal carrier wall 31, 32, respectively, and are fastened thereto via connecting element 35. Front sealing web 51 together with inner platform 21b and an inner platform 55 (only schematically illustrated as a contour) of the upstream rotor blade arrangement forms a labyrinth seal 61, and likewise, rear sealing web 52 together with inner platform 21b of guide blade arrangement 21 and inner platform 56 (only schematically illustrated as a contour) of the downstream rotor blade arrangement forms a labyrinth seal 62.

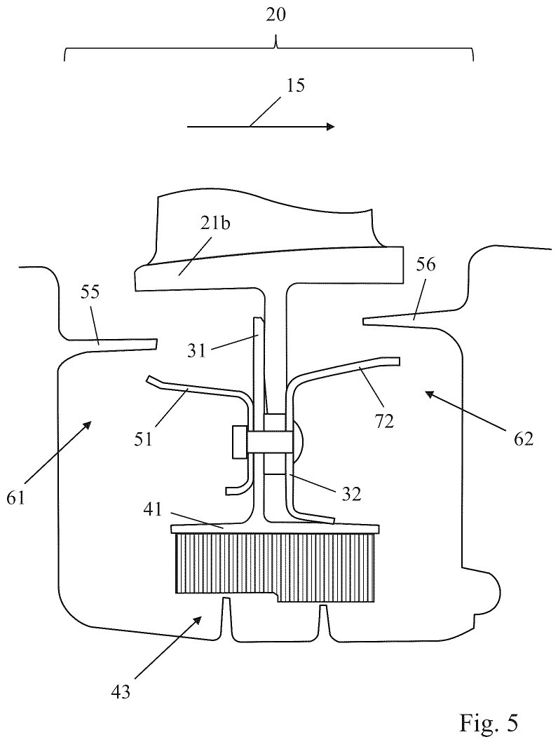

The variant according to FIG. 5 differs from that according to FIG. 4 only in the implementation of rear sealing web 72, which in this case is monolithically formed with second seal carrier wall 32. This design may be achieved, for example, by appropriately bending a metal sheet.

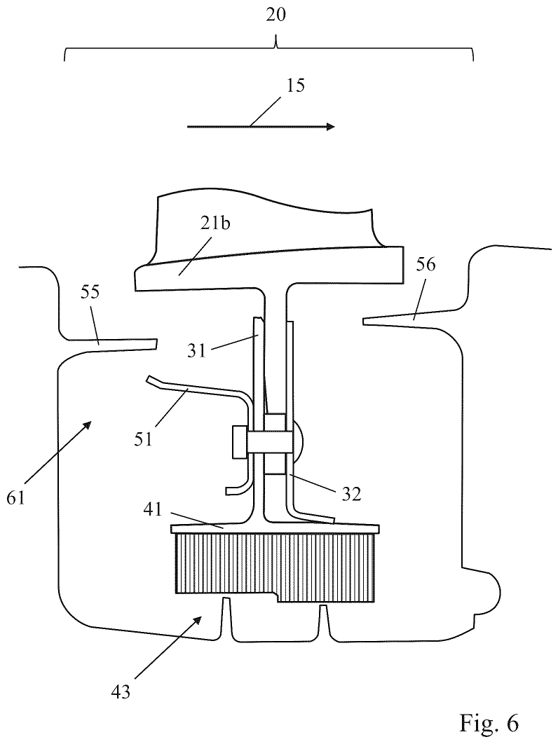

The variant according to FIG. 6 corresponds to FIGS. 4 and 5 with regard to front sealing web 51, but has a simplified design without a rear sealing web.

### LIST OF REFERENCE NUMERALS

1 turbomachine
1a compressor
1b combustion chamber
1c turbine
2 longitudinal axis
15 through flow
20 module
21 guide blade arrangement
21a guide blade airfoil
21b inner platform
21c guide pin
22 clearance
31 first, front seal carrier wall
32 second, rear seal carrier wall
32.1 radially inner section
32.1.1 radially inner end
32a lateral surface
35 connecting element
36 sliding body
41 seal carrier
41a top-side surface
42 sealing element
43 sealing structure
45 step
46 gap
51 front sealing web
52 rear sealing web
55 inner platform
56 inner platform
61 labyrinth seal
62 labyrinth seal
72 rear sealing web

What is claimed is:

1. A module for a turbomachine, the module comprising:
a guide blade arrangement;
a seal carrier situated radially within an inner platform (21b) of the guide blade arrangement;
a first seal carrier wall and a second seal carrier wall;
a sliding body; and
a connector,
the first and second seal carrier walls having a multipart design with respect to one another, the second seal carrier wall being fastened to the first seal carrier wall and to the seal carrier via the connector,
the sliding body holding the first and second seal carrier walls at a distance from one another in such a way that the first and second carrier walls mutually axially delimit a clearance, the guide blade arrangement engaging in the clearance via a radially inwardly extending guide pin,
a radially inner section of the second seal carrier wall having frictional contact relative to the seal carrier.

2. The module as recited in claim 1 wherein the first seal carrier wall is situated upstream and the second seal carrier wall is situated downstream, relative to a through flow through the module.

3. The module as recited in claim 1 wherein the second seal carrier wall axially abuts the seal carrier via the frictional engagement.

4. The module as recited in claim 3 wherein the second seal carrier wall has a lateral surface facing the first seal carrier wall and axially abutting a stage formed in a radially outwardly facing top-side surface of the seal carrier, a gap being formed between a radially inner end of the second seal carrier wall and a top-side surface of the seal carrier.

5. The module as recited in claim 1 wherein the second seal carrier wall radially abuts the seal carrier via the frictional engagement.

6. The module as recited in claim 5 wherein an inner section of the second seal carrier wall, viewed in an axial section, extends radially inwardly at an angle, and radially abuts a radially outwardly facing top-side surface of the seal carrier.

7. The module as recited in claim 6 wherein the radially inner section abuts only with a radially inner end the top-side surface of the seal carrier, and otherwise extends freely.

8. The module as recited in claim 1 further comprising a sealing web, viewed in an axial section, extending away from one of the first and second seal carrier walls and together with the inner platform of the guide blade arrangement forming a labyrinth seal.

9. The module as recited in claim 8 wherein the sealing web has a multipart design with respect to the one of the first and second seal carrier walls, and is fastened to the one of the first and second seal carrier walls via the connector.

10. The module as recited in claim 8 wherein the sealing web is formed monolithically with the one of the first and second seal carrier walls.

11. The module as recited in claim 1 wherein the sliding body has a multipart design with respect to the first and second seal carrier walls, and the connector passes through the sliding body.

12. The module as recited in claim 1 wherein the second seal carrier wall has a smaller thickness than the first seal carrier wall.

13. The module as recited in claim 12 wherein the second seal carrier wall is made of a metal sheet.

14. The module as recited in claim 12 wherein the metal sheet is continuous and free of interruptions in a circumferential direction.

15. The module as recited in claim 1 wherein the first seal carrier wall is formed monolithically with the seal carrier.

16. The module as recited in claim 15 wherein the first seal carrier wall forms a T-shaped cross section with the seal carrier.

17. The module as recited in claim 1 further comprising a sealing element situated at the seal carrier.

18. The module as recited in claim 17 wherein the sealing element is an inlet coating.

19. A turbine for a turbomachine comprising the module as recited in claim 1.

20. An aircraft engine comprising the module as recited in claim 1.
